(19) United States
(12) Patent Application Publication
(10) Pub. No.: US 2026/0303380 A1
(43) Pub. Date: Oct. 1, 2026

(54) LINKING PROPERTIES TO ON-CHAIN DATA STRUCTURES

(71) Applicant: Terr.AI, Princeton, NJ (US)

(72) Inventor: Dipal Mukund PATEL, Pennington, NJ (US)

(73) Assignee: Terr.AI, Princeton, NJ (US)

(21) Appl. No.: 19/096,597

(22) Filed: Mar. 31, 2025

(51) Int. Cl. H04L 9/00; H04L 9/08; H04L 9/30; G06Q 50/163

(52) U.S. Cl. CPC H04L 9/50; H04L 9/0866; H04L 9/30; G06Q 50/163

(57) ABSTRACT

Systems and methods are disclosed herein for linking properties with on-chain data structures. An on-chain processing system may use the following operations to link properties with on-chain data structures. The on-chain processing system may receive a request to obtain control of an on-chain data structure corresponding to immovable property. In response to the request, the on-chain processing system may authenticate the user to determine whether the user controls (e.g., owns) the immovable property in the real world. Based on determining that the user controls the immovable property, the on-chain processing system may retrieve property information associated with that immovable property and encrypt that property information using a public key corresponding to the user. The on-chain processing system may then transmit a data package that includes the encrypted property information to be stored in association with the link within the on-chain data structure.

### BACKGROUND

Until recently, property records have been kept as physical papers in county courthouses and other locations. To look up those records, a person had to go into the courthouse and find the physical records. Furthermore, to get any ownership information about a plot of land or a house within those records, a person had to make physical copies to take away. In recent years, counties have started publishing these records on the Internet. The publication of records enabled easier lookups and analysis of those records by individuals. However, publishing information on the Internet causes additional issues, including overwriting documents with fakes, deletion of the documents, and edits that would cause havoc when lookup is performed. Furthermore, currently available property documents give little information on the condition of the property or any improvements upon it.

### SUMMARY

Accordingly, systems and methods are disclosed herein for linking properties with on-chain data structures so the corresponding property documents cannot be edited and transferring those documents as on-chain properties from one user to another. An on-chain processing system may perform operations described herein. The on-chain processing system may use the following mechanism to link properties with on-chain data structures. The on-chain processing system may receive a request to obtain control of an on-chain data structure corresponding to immovable property. In response to the request, the on-chain processing system may authenticate the user to determine whether the user controls (e.g., owns) the immovable property in the real world. Based on determining that the user controls the immovable property, the on-chain processing system may retrieve property information associated with that immovable property and encrypt that property information using a public key corresponding to the user. The on-chain processing system may then transmit a data package that includes the encrypted property information to be stored in association with the link within the on-chain data structure.

In some embodiments, the on-chain processing system may use the following operations to link properties with on-chain data structures. The on-chain processing system may receive, from a user device corresponding to a user, a first request for obtaining control of an on-chain data structure corresponding to an immovable property of a plurality of immovable properties. The first request may include a first identifier associated with a cryptography-based storage application corresponding to the user and a second identifier corresponding to the immovable property of the plurality of immovable properties. For example, a user may want to take ownership of their home as it is represented on a blockchain. Thus, the user may send a request indicating the identifier of the home (e.g., an identifier of the on-chain data structure representing the home) and the user’s public key (in the form of a user’s address on the blockchain).

When the first request is received, the on-chain processing system may attempt to authenticate the user. In particular, in response to the first request, the on-chain processing system may transmit, to the user, a second request requesting a digital identification associated with the user. The second request may include a listing of permitted identity types. For example, the on-chain processing system may request that the user submit a digital identification to confirm the user’s identity or take a digital photograph of a physical identification to confirm the user’s identity before giving the user control of the on-chain data structure.

The on-chain processing system may then determine, based on the digital identification, whether the user controls the immovable property corresponding to the on-chain data structure. The on-chain processing system may use several mechanisms to perform the determination. For example, the on-chain processing system may retrieve various ownership or other records and compare those records with the user’s identification.

When the on-chain processing system determines that the user owns the immovable property associated with the on-chain data structure, the on-chain processing system may assign the on-chain data structure to the user. In particular, based on determining that the user controls the immovable property, the on-chain processing system may cause an on-chain operation to be executed to assign control of the on-chain data structure to be controlled by the cryptography-based storage application corresponding to the user. For example, the on-chain processing system may assign the on-chain data structure to a blockchain address associated with the user so that the user is able to control (e.g., transfer) the on-chain data structure to another user.

Once the on-chain processing system assigns the on-chain data structure to the user, the on-chain processing system may encrypt the associated data using a public key associated with the user. In particular, the on-chain processing system may retrieve, from the on-chain data structure, a link to property information associated with the immovable property. The property information may be stored off-chain in a suitable location. The link may be an Internet link that enables accessing the associated property information. The property information may be encrypted such that it is not available to be accessed. In some embodiments, the property information may not be initially stored at the link location until the on-chain data structure is claimed by the user who owns the corresponding immovable property.

The on-chain processing system may then encrypt the property information using a public key associated with the cryptography-based storage application to generate an encrypted data package. That is, the on-chain data structure may encrypt the property information so that only a private key associated with the user is enabled to decrypt the property information. The on-chain data structure may then transmit the encrypted data package to a location associated with the link.

When the on-chain data structure has been linked with the user (e.g., via the user’s on-chain address and/or public key), control of the on-chain data structure may be transferred to another user (e.g., when a house is being sold). In addition, the on-chain data structure may be used to share a portion of the property information with various agents for transfer purposes. This may be accomplished using blockchain technology as discussed below.

The on-chain processing system may receive a request to transfer control of the on-chain data structure. In particular, the on-chain processing system may receive, from a first user device corresponding to a first user, a first request for transferring, to a second user, control of an on-chain data structure corresponding to an immovable property of a plurality of immovable properties. The first request may include a first identifier associated with a first cryptography-based storage application associated with the first user, a second identifier corresponding to the on-chain data structure, and a third identifier corresponding to the second user. That is, a transfer request may be generated by an application on a user’s device (e.g., on a smartphone) such that the request may include on-chain data of the owner and the new owner for the transfer to be achieved.

In response to the request, the on-chain processing system may identify the user that is going to receive control of the on-chain data structure. In particular, the on-chain processing system may, in response to the first request, determine, based on the third identifier, a fourth identifier corresponding to a second cryptography-based storage application associated with the second user. For example, the on-chain processing system may determine blockchain information for the second user so that the transfer can be completed.

The on-chain processing system may then determine whether the user has control of the on-chain data structure. In particular, the on-chain processing system may determine, using the first identifier, whether the first user controls the on-chain data structure. For example, the on-chain processing system may retrieve blockchain information indicating whether the user’s on-chain address controls the on-chain data structure.

When the on-chain processing system determines that the user controls the on-chain data structure, the on-chain processing system may proceed with the transfer. In particular, based on determining that the first user controls the on-chain data structure, the on-chain processing system may generate an on-chain operation to transfer control of the on-chain data structure from the first cryptography-based storage application to the second cryptography-based storage application. For example, the on-chain processing system may use blockchain information for both users to perform the transfer.

The on-chain processing system may then cause the property information for the corresponding immovable property to be decrypted and then re-encrypted using a public key of the recipient. In particular, the on-chain processing system may transmit a second request to the first user device. The second request may include the on-chain operation, a link to encrypted property information associated with the immovable property, and one or more instructions to execute the on-chain operation and decrypt the encrypted property information associated with the immovable property. The first user device may then execute the on-chain operation and decrypt the encrypted property information corresponding to the link to generate decrypted property information. As discussed above, the encrypted property information is stored off-chain. Thus, when the user device of the first user decrypts the property information, the first user device may send it to the on-chain processing system to encrypt the data with a public key of the new owner. However, the user device may perform the encryption itself and move the encrypted property information to the link location.

In some embodiments, based on the on-chain operation being completed and the encrypted property information being decrypted, the on-chain processing system may retrieve, using the link (or from its storage or memory), the decrypted property information. For example, the user device may have sent the decrypted information to the link location or to the on-chain processing system server itself. Thus, the on-chain processing system may retrieve the property information in a decrypted format.

The on-chain processing system may then encrypt the property information and place it into an appropriate location. In particular, the on-chain processing system may encrypt the decrypted property information using a public key associated with the second cryptography-based storage application to generate an encrypted data package and transmit the encrypted data package to a location associated with the link.

In some embodiments, the on-chain processing system may temporarily encrypt a portion of the property information to be used in a transfer context. The on-chain processing system may receive, from an operator device, a data request for a subset of the encrypted property information. The subset of the encrypted property information may include a plurality of fields. For example, certain information may be needed by an agent such as build date, title information, size information, and other suitable information.

The on-chain processing system may then determine that the fields being requested are not sensitive or otherwise private and may not be accessed. In particular, the on-chain processing system may determine that the plurality of fields within the subset of the encrypted property information has fields that are not private. That is, a user may not want to share anything private with the agent or other users. In some embodiments, the fields may be flagged as private or not private.

The on-chain processing system may then generate a token with the subset of property information. In particular, the on-chain processing system may transmit, to a second user device associated with the second cryptography-based storage application, a command for generating a single-user temporary token. The single-user temporary token may enable the operator device to access the plurality of fields. Furthermore, the command may include the link and one or more identifiers corresponding to the plurality of fields for processing. In addition, the second user device may use the second cryptography-based storage application to decrypt the plurality of fields.

Various other aspects, features, and advantages of the system will be apparent through the detailed description and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for linking properties with on-chain data structures, in accordance with one or more embodiments of this disclosure.

FIG. 2 illustrates an on-chain program, in accordance with one or more embodiments of this disclosure.

FIG. 3 illustrates an excerpt of a data structure for storing property information for immovable properties, in accordance with one or more embodiments of this disclosure.

FIG. 4 illustrates an example of on-chain data structure 400, in accordance with one or more embodiments of this disclosure.

FIG. 5 illustrates a second request to the first user device, in accordance with one or more embodiments of this disclosure.

FIG. 6 illustrates a data request for a temporary token, in accordance with one or more embodiments of this disclosure.

FIG. 7 illustrates a representation of an addition of generated on-chain program code to an on-chain program, in accordance with one or more embodiments of this disclosure.

FIG. 8 illustrates an exemplary index file and encrypted content files, in accordance with one or more embodiments of this disclosure.

FIG. 9 illustrates a computing system that can be used for generating or testing on-chain program code, in accordance with one or more embodiments of this disclosure.

FIG. 10A is a flowchart of operations for linking on-chain data structures with immovable properties, in accordance with one or more embodiments of this disclosure.

FIG. 10B is a flowchart of operations for modifying on-chain data structures, in accordance with one or more embodiments of this disclosure.

FIG. 11 shows an illustrative diagram for a decentralized environment for performing blockchain functions (sometimes referred to as blockchain operations), in accordance with one or more embodiments.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

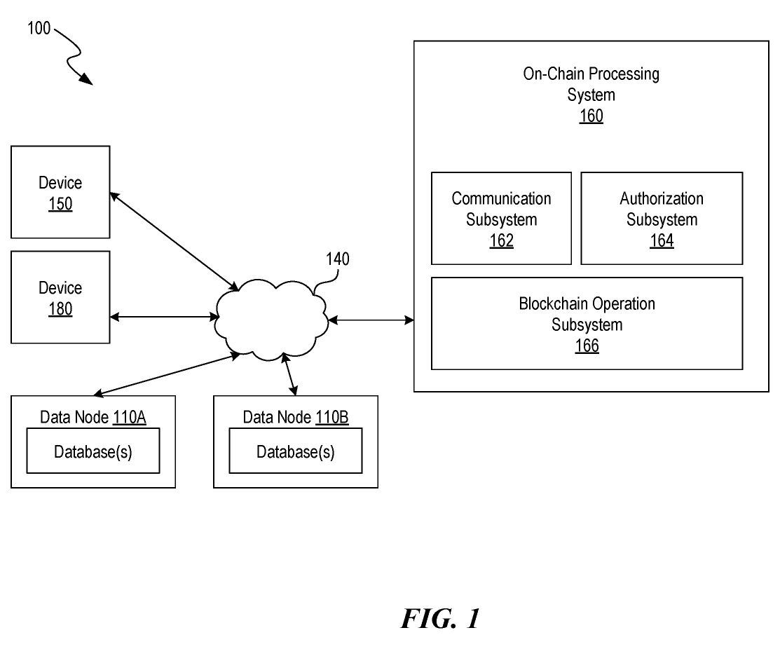

FIG. 1 shows an illustrative system for linking immovable properties with on-chain data structures and enabling transfer control of those data structures during transfer of immovable property. Environment 100 includes on-chain processing system 160, data node 110A, data node 110B, device 150, and device 180.

On-chain processing system 160 of environment 100 may execute operations described herein. On-chain processing system 160 may include several subsystems, each configured to perform one or more operations of the methods and systems described herein. Communication subsystem 162, authorization subsystem 164, and/or blockchain operation subsystem 166 may be used to perform the operations described. On-chain processing system 160 may include software, hardware, or a combination of the two. For example, on-chain processing system 160 may be hosted on a physical server or a virtual server that is running on a physical computer system. In some embodiments, on-chain processing system 160 may be configured on a user device (e.g., a laptop computer, a smartphone, a desktop computer, an electronic tablet, or another suitable user device).

On-chain processing system 160 may be in communication (e.g., via network 140) with a data node 110A, through which the system may access a blockchain. For example, data node 110A may be a blockchain node of a blockchain. Data node 110A may store various data, including user data, copies of on-chain programs, and/or other suitable data. Data node 110A may include software, hardware, or a combination of the two. For example, data node 110A may be a physical server or a virtual server that is running on a physical computer system. In some embodiments, the verification system and data node 110A may reside on the same hardware and/or the same virtual server/computing device. Network 140 may be a local area network, a wide area network (e.g., the Internet), or a combination of the two.

Devices such as device 150 or device 180 may be associated with a cryptography-based storage application used at the data nodes. A cryptography-based storage application may also include software, hardware, or a combination of the two. For example, each cryptography-based storage application may include software executed on one or multiple devices or may include hardware, such as a physical device. In some cases, the cryptography-based storage application may be software and may be stored in user devices (e.g., client devices such as smartphones, laptops, electronic tablets, etc.), and a user of the cryptography-based storage application may access the cryptography-based storage application on those devices. Alternatively, or additionally, the cryptography-based storage application may reside on a special device (e.g., a fob) intended for storing the cryptography-based storage application. For example, the device may store one or more private keys in a memory of the device and allow transactions to be signed (e.g., via generating a cryptographic signature) on the device itself. Examples of cryptography-based storage applications may include cryptographic wallets. For example, a cryptography-based storage application may be referred to as a digital wallet (e.g., hot wallet, cold wallet, etc.). As described herein, some examples of hardware cryptographic wallets include Ledger® and Trezor®. Software cryptographic wallets may include Metamask® and others.

Communication subsystem 162 of on-chain processing system 160 may be used to send and receive data, such as from one or more blockchains accessed through data node 110A via network 140. Communication subsystem 162 may include software components, hardware components, or a combination of both. For example, communication subsystem 162 may include a network card (e.g., a wireless network card and/or a wired network card) that is associated with software to drive the card. Communication subsystem 162 may pass at least a portion of the data, or a pointer to the data in memory, to other subsystems such as authorization subsystem 164 and/or blockchain operation subsystem 166.

In some embodiments, on-chain processing system 160 may enable a property owner to claim their immovable property within the system. On-chain processing system 160 may receive (e.g., via communication subsystem 162), from a user device corresponding to a user, a first request for obtaining control of an on-chain data structure corresponding to an immovable property of a plurality of immovable properties. The first request may include a first identifier associated with a cryptography-based storage application corresponding to the user and a second identifier corresponding to the immovable property of the plurality of immovable properties. As discussed above, a user may attempt to claim their immovable property on the system. In some embodiments, as an initial step, the user may request control of the on-chain data structure. An on-chain data structure may be a blockchain token such as a non-fungible token (NFT). An NFT may be a blockchain or an on-chain data structure (e.g., a token) that represents a particular immovable property. The NFT may be transferred between users using an on-chain program (e.g., a smart contract). An on-chain program may be a script or another suitable code that resides on the blockchain and is enabled to transfer control of created tokens from one user (e.g., a first blockchain address) to a second user (e.g., a second blockchain address). A user’s blockchain address may correspond to a public key and a corresponding private key for signing blockchain operations (e.g., blockchain transactions).

In some embodiments, the user device (e.g., user device 150 and/or user device 180) may host the cryptography-based storage application that stores a private key that is used to sign on-chain operations. For example, a cryptographic wallet (e.g., as described above) may be hosted on the user device. The cryptographic wallet may store one or more private keys associated with the user. Each private key may be used to sign cryptographic transactions to be committed to the blockchain. Each private key may be associated with a public key and a corresponding blockchain address, which identifies the user’s cryptographic wallet on the blockchain.

In some embodiments, the first identifier of the first cryptography-based storage application (e.g., a cryptographic wallet storing one or more private keys) may be a wallet address associated with the user attempting to claim the on-chain data structure. The wallet address may be used to assign the on-chain data structure to the user. The second identifier corresponding to the immovable property of the plurality of immovable properties may be, for example, an address, a block and lot number, or another suitable identifier of an immovable property. For example, on-chain processing system 160 may maintain a database of immovable properties. Each immovable property may include one or more identifiers (e.g., an address, a block and lot number, etc.) along with other information such as an identifier of a corresponding on-chain data structure.

In response to the request from the user to claim the immovable property, on-chain processing system 160 may (e.g., using authorization subsystem 164) confirm that the user in-fact is the owner of the immovable property. In particular, authorization subsystem 164 may, in response to the first request, transmit to the user (e.g., at a user device such as device 150), a second request requesting a digital identification associated with the user. The second request may include a listing of permitted identity types. That is, authorization subsystem 164 may request a know your client (KYC) authentication from the user. The identity types may be things like a passport, driver’s license, and/or another suitable identity type. The user may need to scan the document and also capture a photograph of the user and send those to on-chain processing system 160.

When the digital identification is received, authorization subsystem 164 may authenticate the user as the owner of the immovable property. In particular, authorization subsystem 164 may determine, based on the digital identification, whether the user controls the immovable property corresponding to the on-chain data structure. For example, authorization subsystem 164 may receive a photo of the user and a corresponding digital identification (e.g., a scan of a passport, a driver’s license, etc.). Authorization subsystem 164 may then determine whether the digital identification document matches the photo (e.g., using face recognition technology). Furthermore, authorization subsystem 164 may retrieve any documents associated with the immovable property (e.g., a deed) and determine whether the name of the deed or another suitable identifier matches the user’s digital identification (e.g., a name). It should be noted that other mechanisms may be used to authenticate and authorize the user. For example, authorization subsystem 164 may use a machine learning model to compare the user’s name and other user data with information on the property information within the documents associated with the immovable property to predict whether the user owns the immovable property. For example, the machine learning model may take, as input, the immovable property documents and user information (e.g., name, age, gender, etc.). In some embodiments, user information may include demographic information.

When authorization subsystem 164 authorizes the user and determines that the user owns the immovable property, on-chain processing system 160 may assign the corresponding on-chain data structure (e.g., a blockchain token such as an NFT) to be controlled by the user’s cryptography-based storage application (e.g., cryptographic wallet). Authorization subsystem 164 may pass information to blockchain operation subsystem 166 to perform the assignment operation. Blockchain operation subsystem 166 may, based on determining that the user controls the immovable property, cause an on-chain operation to be executed to assign control of the on-chain data structure to be controlled by the cryptography-based storage application corresponding to the user.

In some embodiments, blockchain operation subsystem 166 may use the blockchain to assign control of the on-chain data structure. Blockchain operation subsystem 166 may perform the following operations when causing the on-chain operation to be executed to assign control of the on-chain data structure to be controlled by the cryptography-based storage application (e.g., a cryptographic wallet). Blockchain operation subsystem 166 may retrieve an identifier associated with the on-chain data structure. For example, blockchain operation subsystem 166 may retrieve a token address associated with the token (e.g., an NFT) on the blockchain. As discussed above, on-chain processing system 160 may maintain a database of immovable properties (e.g., retrieved from county records and other sources). Each immovable property may be associated with a blockchain token (e.g., an NFT) that may be generated by an on-chain program (e.g., a smart contract).

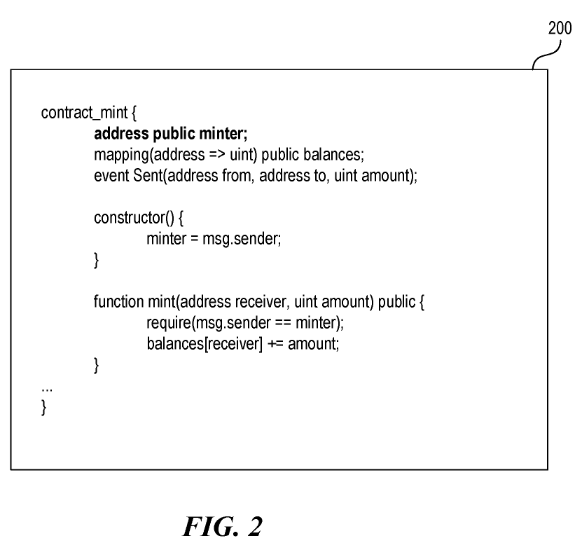

As described herein, an on-chain program or on-chain program code may refer to a computer program or any suitable code for performing computing operations stored on a blockchain. For example, an on-chain program may reference a program stored on a blockchain or another distributed ledger. In particular, an on-chain program may be used to automate the execution of a transaction, such as a blockchain operation. In some examples, an on-chain program may refer to a smart contract executed on a blockchain. In one example, an on-chain program may run when predetermined conditions are satisfied. For example, FIG. 2 illustrates an on-chain program 200 designated in accordance with one or more embodiments of this disclosure. For example, the on-chain program 200 represents a smart contract for minting “contract_mint” that sends an amount of newly created tokens to an address and can only be called by the contract creator. Thus, the on-chain program may be used to generate (e.g., mint) all the tokens (e.g., NFTs) to associate with each immovable property.

When the on-chain data structure associated with the immovable property is identified, blockchain operation subsystem 166 may proceed to generate the blockchain operations. In particular, blockchain operation subsystem 166 may generate the on-chain operation that uses the identifier to assign the on-chain data structure to be controlled by the cryptography-based storage application. For example, blockchain operation subsystem 166 may generate a blockchain transaction that transfers control of the on-chain data structure from the cryptography-based storage application associated with on-chain processing system 160 to the cryptography-based storage application associated with the user.

The blockchain operation may then be sent to a blockchain node to be committed to the blockchain. In particular, blockchain operation subsystem 166 may transmit a command to a blockchain node to execute the on-chain operation (e.g., using a smart contract). The command may include a cryptographic signature generated using a private key associated with a server. That is, because the on-chain data structure (e.g., a token such as an NF) has been generated and not assigned to a user, the first user that is claiming the immovable property will receive control of the on-chain data structure from a server where the on-chain processing system 160 is hosted. Thus, on-chain processing system 160 may use a private key residing within a cryptography-based storage application hosted by the server to perform the transfer of control of the on-chain data structure.

When the on-chain data structures are generated or at a time afterwards, blockchain operation subsystem 166 may generate a corresponding link for each immovable property linking each on-chain data structure to property information related to the corresponding immovable property. The link may be used to retrieve documents and other information associated with the immovable property. The link may be necessary because the blockchain does not allow for storing a large amount of information. Thus, blockchain operation subsystem 166 may retrieve, from the on-chain data structure, a link to property information associated with the immovable property. As discussed above, the property information may be stored off-chain and may be encrypted using a public key associated with the server. In some embodiments, the link may be encrypted using the same public key of the server so that only the server is enabled to decrypt the link using a corresponding private key.

In some embodiments, blockchain operation subsystem 166 may retrieve the link to the property information from the on-chain data structure. In particular, blockchain operation subsystem 166 may retrieve an identifier associated with the on-chain data structure. As discussed above, the identifier may be a blockchain address of the on-chain data structure (e.g., NFT). The blockchain address may be stored in a database in association with the immovable property. Thus, blockchain operation subsystem 166 may retrieve the identifier of the on-chain data structure.

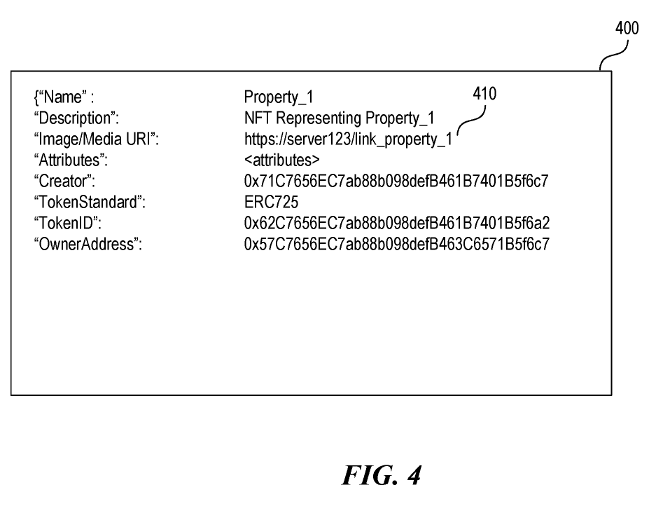

When the identifier has been retrieved or determined, blockchain operation subsystem 166 may query a node (e.g., a blockchain node such as data node 110A) using the identifier for a corresponding on-chain data structure to retrieve metadata and other data associated with the on-chain data structure. FIG. 4 illustrates an example of on-chain data structure 400 that may be one or more parameters of an NFT. Link 410 within FIG. 4 may be a link to the immovable property information location at a server or at another suitable location. Thus, blockchain operation subsystem 166 may retrieve, from the on-chain data structure (e.g., from an NFT), the link (e.g., a parameter of the NFT) to the property information.

In some embodiments, blockchain operation subsystem 166 may perform the following operations to generate the on-chain data structures and the corresponding links to the property information associated with different immovable properties. Blockchain operation subsystem 166 may retrieve, from one or more databases, a plurality of property identifiers corresponding to the plurality of immovable properties. For example, a property identifier may include a property address or another suitable identifier such as a block and lot number together with a county identifier. In some embodiments, the value may be hashed or somehow otherwise encoded for easier processing.

Blockchain operation subsystem 166 may then cause generation of the on-chain data structures (e.g., digital tokens such as NFTs) for the immovable properties. In particular, blockchain operation subsystem 166 may generate, using an on-chain program, a plurality of on-chain data structures representing the plurality of immovable properties. As discussed above, the on-chain program may be a smart contract that has been installed onto the blockchain. The on-chain program (e.g., smart contract) may generate the on-chain data structures (e.g., NFTs) and assign initial control of those on-chain data structures to a cryptography-based storage application associated with the server. That is, the smart contract may be configured to mint NFTs on chain when the smart contract is executed by a blockchain node. Thus, blockchain operation subsystem 166 may send a command to the blockchain node to perform the minting operation using the smart contract.

Blockchain operation subsystem 166 may retrieve a plurality of immovable property information sets for the plurality of immovable properties. For example, the immovable property information may be initially stored in a database. Once the corresponding on-chain data structure has been created, blockchain operation subsystem 166 may retrieve the required information from the database to copy or move that data to the link location. The link location may be a location on one or more servers that may be accessed using the link.

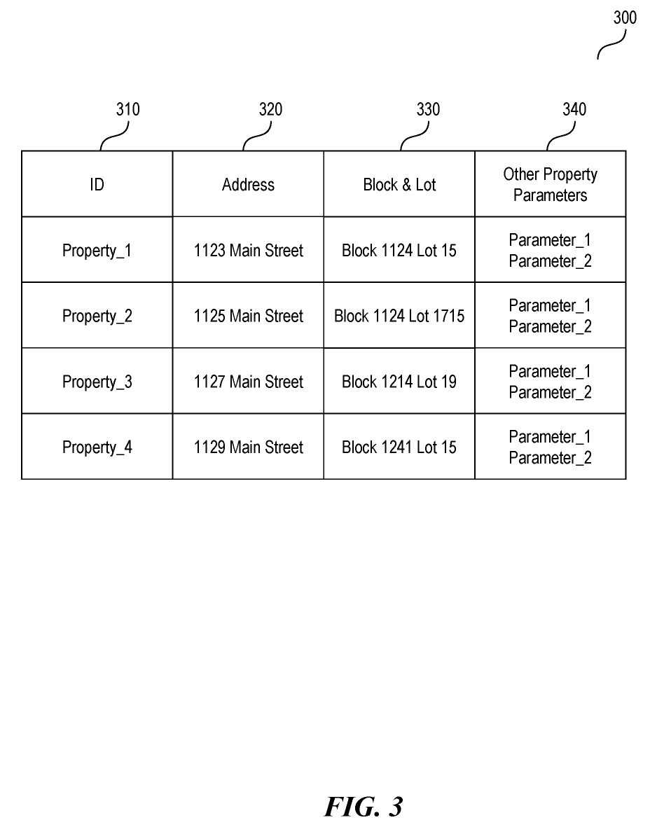

FIG. 3 illustrates an excerpt of data structure 300 for storing property information for immovable properties. Data structure 300 may include a field 310 that identifies the immovable property. Field 320 may store the address of the property and field 330 may store block and lot number of the property. Field 340 may be one or more fields that store other parameters of the property. Some data within field 340 or fields 340 may include various documents related to the immovable property, or example, whether the property has a home built on it and various information about the home such as any warranties (e.g., roof age and warranty data) and other suitable information.

Blockchain operation subsystem 166 may then link the on-chain data structure with the property information associated with each immovable property. In particular, blockchain operation subsystem 166 may link each on-chain data structure of the plurality of on-chain data structures with a corresponding immovable property information set of the plurality of immovable property information sets. For example, blockchain operation subsystem 166 may insert a corresponding link to the location of the documents for a particular immovable property into each on-chain data structure. In some embodiments, the link may be encrypted. However, the link may be unencrypted in some embodiments. Blockchain operation subsystem 166 may retrieve the property information from the database and move or copy the property information into a proper location (e.g., after encrypting the data).

In some embodiments, blockchain operation subsystem 166 may perform the following operations when linking each on-chain data structure of the plurality of on-chain data structures with the corresponding immovable property information set of the plurality of immovable property information sets. Blockchain operation subsystem 166 may select a first on-chain data structure of the plurality of on-chain data structures. For example, blockchain operation subsystem 166 may iterate through each on-chain data structure to link the immovable property information.

Blockchain operation subsystem 166 may determine a first property identifier associated with the first on-chain data structure of the plurality of on-chain data structures. For example, blockchain operation subsystem 166 may retrieve (e.g., from a database) an identifier (e.g., as shown in FIG. 3), a combination of a block and lot number with a county, an address, or another suitable identifier.

Blockchain operation subsystem 166 may then generate, based on the first property identifier, the link to the corresponding immovable property information set. For example, the link may include a combination of an Internet address and the identifier. In some embodiments, blockchain operation subsystem 166 may take the identifier and hash it or otherwise encode it. Once hashed or encoded, the identifier may be added to the end of the Internet address. Once the link is generated, blockchain operation subsystem 166 may add the property identifier and/or the link to a corresponding on-chain data structure. Thus, blockchain operation subsystem 166 may store the first property identifier within the on-chain data structure. In some embodiments, to retrieve the immovable property information, on-chain processing system 160 may use the link to query a server to retrieve the data. However, in some embodiments, on-chain processing system 160 may use the identifier to generate a link and then query the link location for the data. For example, on-chain processing system 160 may have the Internet address and then hash the identifier to generate the link.

Turning back to the process for the user to claim their immovable property, on-chain processing system 160 may encrypt the immovable property using a public key of the user so that only the corresponding private key is able to decrypt the immovable property information. In particular, on-chain processing system 160 may encrypt the property information using a public key associated with the cryptography-based storage application to generate an encrypted data package. For example, the public key of the user may be at least a portion of the on-chain identifier (e.g., on-chain address) associated with the cryptography-based storage application of the user. In some embodiments, at least a portion of the on-chain identifier (e.g., the on-chain address) may be used (e.g., as a seed) to derive the public key.

On-chain processing system 160 may retrieve the property information (e.g., using the link within the on-chain data structure) and encrypt the data into the data package. In some embodiments, the property information may initially be stored in a database and then retrieved by on-chain processing system 160 before being encrypted on a device hosting on-chain processing system 160 using a public key associated with the user (e.g., associated with the cryptography-based storage application of the user). For example, the public key may be a portion of the user’s blockchain address or may be derived from at least a portion of the blockchain address of the user’s cryptographic wallet. However, in some embodiments, the property information may be encrypted with a public key associated with a cryptographic wallet of the server hosting the cryptography-based storage application corresponding to the server. In this case, on-chain processing system 160 may decrypt the property information using a corresponding private key of the server and may then re-encrypt the property information.

In some embodiments, on-chain processing system 160 may perform the following operations when encrypting the property information using the public key associated with the cryptography-based storage application to generate the encrypted data package. On-chain processing system 160 may transmit, to a node (e.g., a blockchain node), a query for the on-chain data structure. The query may include an identifier of the on-chain data structure. For example, on-chain processing system 160 may send a request to a blockchain node for token information for an NFT corresponding to a particular immovable property. In response to the query, the blockchain node may send the data of the on-chain data structure (e.g., as shown in FIG. 4). Thus, on-chain processing system 160 may receive, from the node, the on-chain data structure.

On-chain processing system 160 may then use the on-chain data structure to derive the public key. In particular, on-chain processing system 160 may extract from the on-chain data structure an indicator of a controlling cryptography-based storage application to be used as the public key. Because the on-chain data structure has already been assigned to the user, the controlling cryptography-based storage application will be that of the user. In some embodiments, the identifier may be a blockchain address associated with the user. For example, on-chain processing system 160 may use at least a portion of the blockchain address of the user as a public key or may use at least a portion of the blockchain address of the user to derive the public key.

Once the data package is created, on-chain processing system 160 may transmit the encrypted data package to a location associated with the link. The location may be on a server hosting on-chain processing system 160 or on another suitable device. As a result, the system may determine that the particular immovable property has been claimed.

When an immovable property has been claimed, it may be transferred to another user (e.g., when sold). In addition, the described system may provide information about the immovable property during the transfer process to help make the transfer more efficient. The process may begin with a request by the first user to transfer control of the on-chain data structure to another user. In particular, on-chain processing system 160 may receive (e.g., via communication subsystem 162), from a first user device corresponding to a first user, a first request for transferring, to a second user, control of an on-chain data structure corresponding to an immovable property of a plurality of immovable properties. For example, a user may want to transfer control of the on-chain data structure corresponding to an immovable property to another user. The user may use a cryptography-based storage application (e.g., a cryptographic wallet) to perform the transfer. The application on a user’s device may generate a request for the transfer of control of the on-chain data structure.

In some embodiments, the request may include a first identifier associated with a first cryptography-based storage application associated with the first user, a second identifier corresponding to the on-chain data structure, and a third identifier corresponding to the second user. The request may include this information so that this information may be used during the transfer as will be described below. In some embodiments, the first request may include a cryptographic signature for verifying the requestor. For example, the first identifier may help on-chain processing system 160 to identify and/or derive the public key associated with the user. The public, key may be used to authorize the user’s cryptographic signature attached to the request. The first identifier may be a wallet address associated with the user from which a public key may be derived, with the corresponding private key residing with the cryptographic wallet on the user’s device. The second identifier may be a blockchain address of the on-chain data structure (e.g., the NFT).

When the request is received, on-chain processing system 160 may determine whether the first user controls the on-chain data structure. For example, on-chain processing system 160 may use blockchain operation subsystem 166 to authenticate the cryptographic signature received with the request. To authenticate the cryptographic signature, blockchain operation subsystem 166 may retrieve and use an identifier associated with the user (e.g., cryptographic wallet address) to derive a public key for the user and then use the public key to authenticate the cryptographic signature.

When on-chain processing system 160 authenticates the user, on-chain processing system 160 may generate a blockchain operation to transfer control of the on-chain data structure. In particular, blockchain operation subsystem 166 may, based on determining that the first user controls the on-chain data structure, generate an on-chain operation to transfer control of the on-chain data structure from a first cryptography-based storage application corresponding to the first user to a second cryptography-based storage application corresponding to the second user. Blockchain operation subsystem 166 may use an on-chain program to perform the operation.

In some embodiments, blockchain operation subsystem 166 may determine a target blockchain address for transferring the on-chain data structure. In particular, blockchain operation subsystem 166 may, in response to the first request, determine, based on the third identifier, a fourth identifier corresponding a second cryptography-based storage application associated with the second user. In some embodiments, blockchain operation subsystem 166 may receive a user identifier for the target user and determine a target blockchain address for the user. For example, the target user’s blockchain address may be stored in a database (e.g., because the second user has registered with the system).

When on-chain processing system 160 determines that the first user controls the on-chain data structure, on-chain processing system 160 may initiate the transfer. In particular, blockchain operation subsystem 166 may transmit a second request to the first user device. The first user device may execute the on-chain operation and may decrypt encrypted property information corresponding to the immovable property to generate decrypted property information. In this instance, the encrypted property information may be stored off-chain. Because the on-chain data structure is controlled by the private key residing on the device of the first user, the transfer should be a blockchain operation request sent from the first user’s device. That way, the private key never leaves the first user’s device and may be used to sign the blockchain operation initiating the transfer. The first user device may submit a blockchain operation request to a blockchain node (e.g., data node 110A or data node 110B) which will commit the transfer to the blockchain. Data node 110A and/or data node 110B may be blockchain nodes.

Because the immovable property information is encrypted with the public key corresponding to the first user, that property information has to be decrypted on the first user’s device. That way, the private key residing on the first user’s device is never sent anywhere. Accordingly, blockchain operation subsystem 166 may receive the decrypted property information from the first user device.

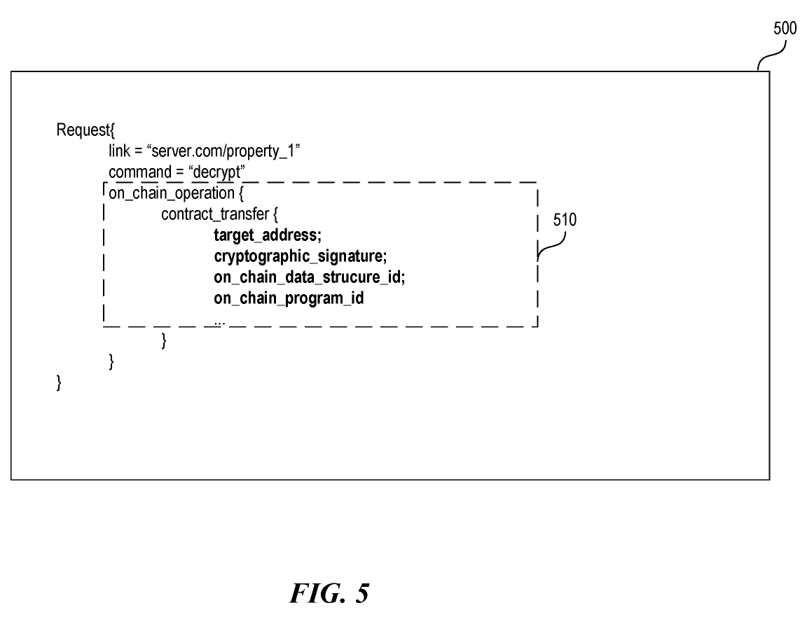

In some embodiments, the second data request may include the on-chain operation, a link to encrypted property information associated with the immovable property and one or more instructions to execute the on-chain operation and decrypt the encrypted property information associated with the immovable property. For example, when the second request is sent, the link to the encrypted property information may be included with the request. However, in some embodiments, the link to the encrypted property information may be retrieved from the on-chain data structure by the first user device. The blockchain operation itself may be an instruction for the cryptography-based storage application (e.g., the cryptographic wallet) to execute the blockchain operation. However, the first user device may sign the blockchain operation with the stored private key. The instructions may further include a command to decrypt the encrypted property information. FIG. 5 illustrates a second request 500 to the first user device. Second request 500 may include the blockchain operation 510 together with the link to the property information and the command to decrypt the property information.

Once the decryption is completed, on-chain processing system 160 may receive the decrypted property information for encryption using a public key of the second user. In particular, based on the on-chain operation being completed and the encrypted property information being decrypted, on-chain processing system 160 may receive the decrypted property information. In some embodiments, the property information may be received from the first user device. That is, the first user device my retrieve the property information using the link, decrypt that property information, and then send it to on-chain processing system 160 (e.g. using communication subsystem 162). In some embodiments, on-chain processing system 160 may retrieve the property information from the link location. For example, the first user device may retrieve the encrypted property information and then decrypt it using, for example, the corresponding private key. The first user device may then transmit the data back to the location associated with the link. On-chain processing system 160 may then query the location and move the decrypted data (e.g., copy and delete) to the server for encryption.

When on-chain processing system 160 receives the decrypted property information, on-chain processing system 160 may encrypt the property information using a public key associated with the second user (e.g., a public key corresponding with the cryptography-based storage application associated with the second user). In particular, on-chain processing system 160 may encrypt the decrypted property information using a public key associated with the second cryptography-based storage application to generate an encrypted data package. For example, on-chain processing system 160 may retrieve the public key associated with the second user. In some embodiments, on-chain processing system 160 may retrieve the public key from a database. The public key may have been stored within the database when the second user has registered with the system. In some embodiments, however, on-chain processing system 160 may derive the public key from the user’s identifier on the blockchain (e.g., the user’s blockchain address). When the key is received, on-chain processing system 160 may encrypt the property information using the public key. Thus, the property information may only be decrypted by the corresponding private key. In some embodiments, on-chain processing system 160 may so encrypt, using the public key, the link prior to updating the on-chain data structure with the link. That is, the link may also be encrypted and may only be decrypted by the corresponding private key.

On-chain processing system 160 may then transmit (e.g., using communication subsystem 162) the encrypted data package to a predetermined storage location. In some embodiments, the predetermined location may be the location associated with the link. This enables continuity of using the link to retrieve the property information. However, in some embodiments, on-chain processing system 160 may generate a new link and store the encrypted property information at the location associated with the new link. Once the property data is encrypted and transmitted to a location of the associated link, the property data may be accessed (e.g., read). For example, the second user using a second device may access the location and decrypt the property information. The second user may then have the decrypted property information on the second device and may view the different documents associated with the property information. In addition, the second user may be allowed to transmit the documents to other users.

In some embodiments, on-chain processing system 160 may aid in the process of transfer of the immovable property to the second user. For example, an agent may require certain information and/or documents about the immovable property. Thus, on-chain processing system 160 may create a temporary package for the agent. Thus, on-chain processing system 160 may receive, from an operator device, a data request for a subset of the encrypted property information. The subset of the encrypted property information may include a plurality of fields. For example, an agent (e.g., real estate agent) may want access to some of the property information to transfer the immovable property. Such information may include build date, age of the roof, renovation times, survey document, and/or other suitable information. Thus, on-chain processing system 160 may receive from the operator device (e.g., agent’s device) a request for that information.

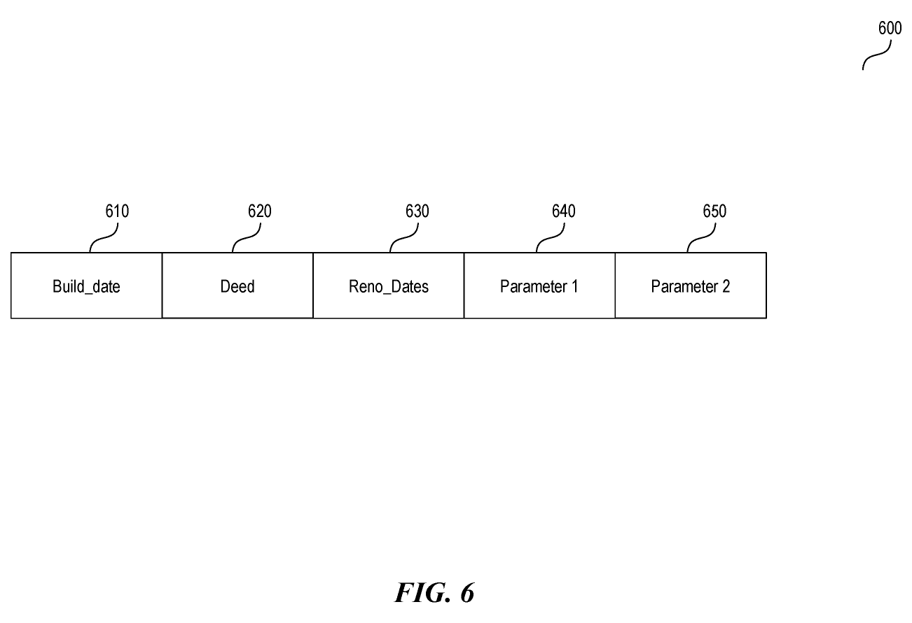

FIG. 6 illustrates a data request 600 for a temporary token. Field 610 may include a request for a build date, which may be a parameter that requires textual data. Field 620 may include a request for a deed, which may be a document type field. Field 630 may request one or more dates for renovation and various information about those renovations. Field 640 and field 650 may include other requested parameters.

When the request is received, on-chain processing system 160 may determine whether permissions have been given to send out information stored within the fields. In particular, on-chain processing system 160 may determine that the plurality of fields includes the subset of the encrypted property information having fields that are not private. That is, the user may set certain fields private and restrict the information from those fields to be sent to the agent. In some embodiments, on-chain processing system 160 may authorize the agent based on a permission list received from the user. In yet some embodiments, on-chain processing system 160 may authorize the agent based on the corresponding cryptography-based storage application (e.g., cryptographic wallet). That is, the agent may register with on-chain processing system 160 using a corresponding cryptography-based storage application (e.g., cryptographic wallet), and on-chain processing system 160 may store the wallet address and/or another suitable wallet identifier within a database of registered users. The user having control of the on-chain data structure may then select registered users to give access to certain property information.

When the permissions have been verified and/or the user has been authenticated, on-chain processing system 160 may cause a temporary token such as a temporary on-chain data structure to be generated for the agent. In particular, blockchain operation subsystem 166 may transmit, to a second user device associated with the second cryptography-based storage application, a command for generating a single-user temporary token. The single-user temporary token may enable the operator device to access the plurality of fields. Furthermore, the command may include a link to the encrypted property information and one or more identifiers corresponding to the plurality of fields. In addition, the second user device may use the second cryptography-based storage application to decrypt the plurality of fields.

In one example, the user may give an agent permissions for a particular set of fields (e.g., parameters and/or documents). On-chain processing system 160 may generate a single-user temporary token which may be an NFT or another suitable on-chain data structure. The NFT may include a link (as described above), but to a subset of all the property information. The property information may have been encrypted using the public key of the agent’s cryptographic wallet. Thus, only the agent’s cryptographic wallet may be able to decrypt the subset of the property information using a corresponding private key.

In some embodiments, the single-user temporary token may be generated using the following operations. On-chain processing system 160 may receive a plurality of data values for the plurality of fields from the second user device. For example, when on-chain processing system 160 receives a request to generate the single-user temporary token, on-chain processing system 160 may send a request to the second user device for the property information corresponding to the request fields. The second user device may use a private key of the cryptography-based storage application that the second user device is hosting to decrypt the property information. In some embodiments, the property information for a particular immovable property may be encrypted into a single file and that full file may need to be sent to the second user device to be decrypted.

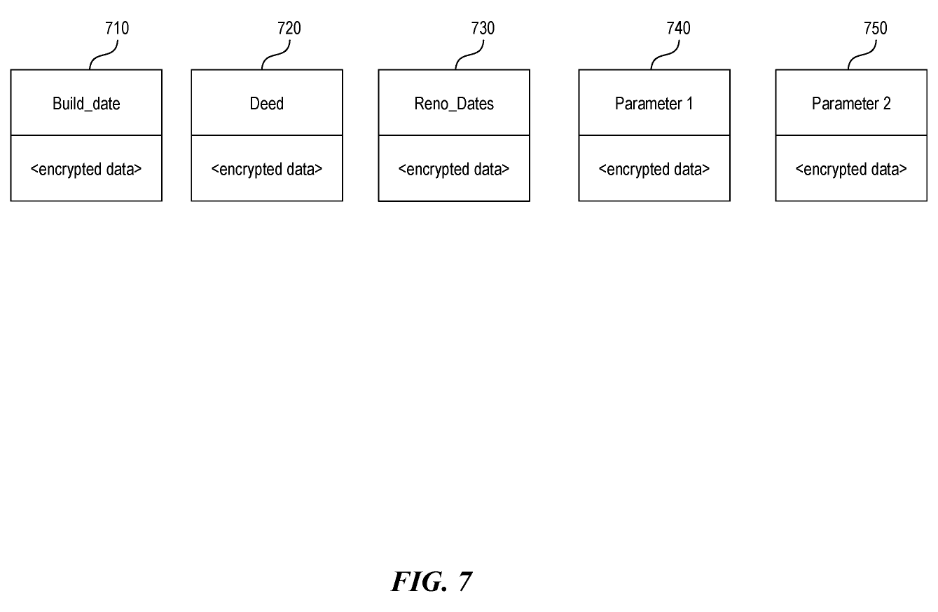

However, in some embodiments, each portion (e.g., parameter or file) may be encrypted separately and may include unencrypted metadata. Thus, on-chain processing system 160 may retrieve only the fields that are needed for the single-user temporary token. FIG. 7 illustrates a plurality of data structures storing encrypted data and accompanying metadata. For example, file 710 may include encrypted data together with metadata for a build date, while file 720 may include an encrypted document and metadata indicating that the document is a deed. File 730 may include encrypted renovation dates and other details. Files 740 and 750 may include other parameters and/or files.

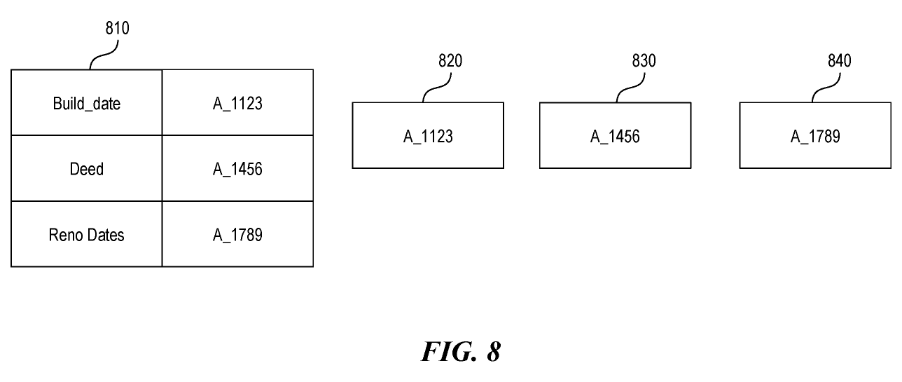

In yet some embodiments, the encrypted data may be stored in encrypted files with particular file names, while the contents of the files may be stored in an index file or another type of file. FIG. 8 illustrates an index file and encrypted content files. File 810 may be an index file which indicates which files within the storage location hold which property information portions. For example, file 810 may indicate that file 820 holds a build_date, while 830 holds the deed, and file 840 holds renovation data. Other arrangements may be possible as well. For example, all textual data may be stored in one file, while documents (e.g., deed) may be stored in separate files. In some embodiments, images may be stored as well (e.g. images of various equipment with the home).

Once the portions of the property information have been retrieved, on-chain processing system 160 may encrypt those portions using the operator’s (e.g., the agent’s) public key so only the agent is able to access the data. Thus, on-chain processing system 160 may retrieve an operator public key associated with an operator cryptography-based storage application. As discussed above, the operator cryptography-based storage application may correspond to the operator device. For example, the public key may be retrieved from a database where the public key has been stored during a registration process. In some embodiments, blockchain operation subsystem 166 may derive the public key from the operator’s cryptography-storage application identifier. For example, blockchain operation subsystem 166 may derive the public key from the wallet address associated with the agent.

On-chain processing system 160 may then encrypt the plurality of data values using the operator public key into encrypted values. On-chain processing system 160 may then generate a temporary access on-chain data structure for accessing the plurality of data values. Once the data has been encrypted, it may be stored in a location linked to the temporary access on-chain data structure. The link may be generated using a mechanism similar to that described above in connection to generating the on-chain data structure. Once generated, the temporary access on-chain data structure may be used by the operator (e.g., the agent) to access the linked subset of the property information, for example, if an agent would like to show a potential user various information regarding the immovable property.

In some embodiments, on-chain processing system 160 may use the following operations to generate the temporary access on-chain data structure. In particular, on-chain processing system 160 may generate a temporary link for storing the encrypted values. For example, on-chain processing system 160 may create a storage location for the link (e.g., a folder on a server) and set the link to access the folder.

On-chain processing system 160 may then instruct blockchain operation subsystem 166 to generate an on-chain command that uses an on-chain program to generate a new on-chain data structure. The on-chain command may include the temporary link and an identifier corresponding to the operator cryptography-based storage application. For example, blockchain operation subsystem 166 may generate a command for a smart contract to mint an NFT which may be the temporary access on-chain data structure. The command may also instruct the blockchain node (e.g., data node 110A or data node 110B) to insert the link into the NFT. On-chain processing system 160 may then transmit (e.g., using communication subsystem 162) the on-chain command to a blockchain node of a blockchain to commit the temporary access on-chain data structure to the blockchain. When the blockchain node commits the transaction, the temporary access on-chain data structure may be generated and ready to use.

In some embodiments, on-chain processing system 160 may set a time threshold for disabling the temporary access on-chain data structure. For example, once the time threshold expires, on-chain processing system 160 may erase the data from the link’s location rending the temporary access on-chain data structure inoperable. On-chain processing system 160 may perform the following operations to disable the temporary on-chain data structure. On-chain processing system 160 may determine that temporary access on-chain data structure has expired. In some embodiments, the temporary access on-chain data structure may store one or more expiration criteria on a blockchain. For example, the temporary access on-chain data structure may store a creation date together with a validity period which may be used by on-chain processing system 160 to disable the temporary access on-chain data structure. In some embodiments, the temporary access on-chain data structure may store an expiration date that on-chain processing system 160 may use in this process.

Based on determining that the temporary access on-chain data structure has expired (e.g., the expiration date and/or time has been reached), on-chain processing system 160 may retrieve a corresponding link from the temporary access on-chain data structure. For example, blockchain operation subsystem 166 may generate and execute a query against the blockchain to get the link from a corresponding NFT or from another suitable data structure. On-chain processing system 160 may then delete the encrypted data package from a network location associated with a link to the encrypted property information. For example, on-chain processing system 160 may have administrator access to the location and may delete the data.

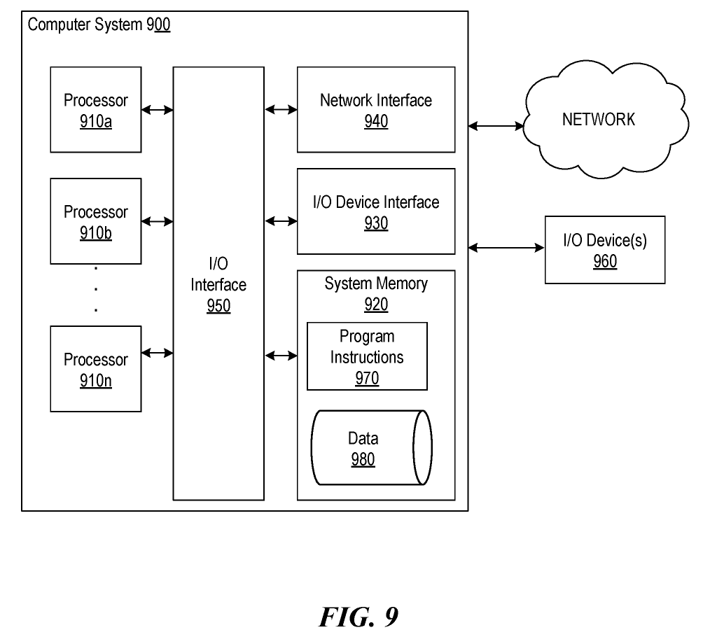

FIG. 9 shows an example computing system that may be used in accordance with some embodiments of this disclosure. In some instances, computing system 900 is referred to as a computer system 900. A person skilled in the art would understand that those terms may be used interchangeably. The components of FIG. 9 may be used to perform some or all operations discussed in relation to FIGS. 1-8. Furthermore, various portions of the systems and methods described herein may include or be executed on one or more computer systems similar to computing system 900. Further, processes and modules described herein may be executed by one or more processing systems similar to that of computing system 900.

Computing system 900 may include one or more processors (e.g., processors 910a-910n) coupled to system memory 920, an input/output (I/O) device interface 930, and a network interface 940 via an I/O interface 950. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 900. A processor may execute code (e.g., processor firmware, a protocol stack, a database management system, an operating system, or a combination thereof) that creates an execution environment for program instructions.

A processor may include a programmable processor. A processor may include general or special-purpose microprocessors. A processor may receive instructions and data from a memory (e.g., system memory 920). Computing system 900 may be a uni-processor system including one processor (e.g., processor 910a) or a multiprocessor system including any number of suitable processors (e.g., 910a-910n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special-purpose logic circuitry, e.g., an FPGA (field-programmable gate array) or an ASIC (application-specific integrated circuit). Computing system 900 may include a plurality of computing devices (e.g., distributed computer systems) to implement various processing functions.

I/O device interface 930 may provide an interface for connection of one or more I/O devices 960 to computer system 900. I/O devices may include devices that receive input (e.g., from a user) or output information (e.g., to a user). I/O devices 960 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 960 may be connected to computer system 900 through a wired or wireless connection. I/O devices 960 may be connected to computer system 900 from a remote location. I/O devices 960 located on remote computer systems, for example, may be connected to computer system 900 via a network and network interface 940.

The I/O device interface 930 and I/O devices 960 may be used to enable manipulation of the three-dimensional model as well. For example, the user may be able to use I/O devices such as a keyboard and touchpad to indicate specific selections for nodes, adjust values for nodes, select from the history of machine learning models, select specific inputs or outputs, and/or the like. Alternatively, or additionally, the user may use their voice to indicate specific nodes, specific models, and/or the like via the voice recognition device and/or microphones.

Network interface 940 may include a network adapter that provides for connection of computer system 900 to a network. Network interface 940 may facilitate data exchange between computer system 900 and other devices connected to the network. Network interface 940 may support wired or wireless communication. The network may include an electronic communication network, such as the Internet, a LAN, a WAN, a cellular communications network, or the like.

System memory 920 may be configured to store program instructions 970 or data 980. Program instructions 970 may be executable by a processor (e.g., one or more of processors 910a-910n) to implement one or more embodiments of the present techniques. Program instructions 970 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 920 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 920 may include a non-transitory, computer-readable storage medium that may have program instructions stored thereon that are executable by a computer processor (e.g., one or more of processors 910a-910n) to cause the subject matter and the functional operations described herein. A memory (e.g., system memory 920) may include a single memory device and/or a plurality of memory devices (e.g., distributed memory devices).

I/O interface 950 may be configured to coordinate I/O traffic between processors 910a-910n, system memory 920, network interface 940, I/O devices 960, and/or other peripheral devices. I/O interface 950 may perform protocol, timing, or other data transformations to convert data signals from one component (e.g., system memory 920) into a format suitable for use by another component (e.g., processors 910a-910n). I/O interface 950 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 900 or multiple computer systems 900 configured to host different portions or instances of embodiments. Multiple computer systems 900 may provide for parallel or sequential processing/execution of one or more portions of the techniques described herein.

Those skilled in the art will appreciate that computer system 900 is merely illustrative and is not intended to limit the scope of the techniques described herein. Computer system 900 may include any combination of devices or software that may perform or otherwise provide for the performance of the techniques described herein. For example, computer system 900 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 900 may also be connected to other devices that are not illustrated or may operate as a stand-alone system. In addition, the functionality provided by the illustrated components may, in some embodiments, be combined in fewer components or be distributed in additional components. Similarly, in some embodiments, the functionality of some of the illustrated components may not be provided, or other additional functionality may be available.

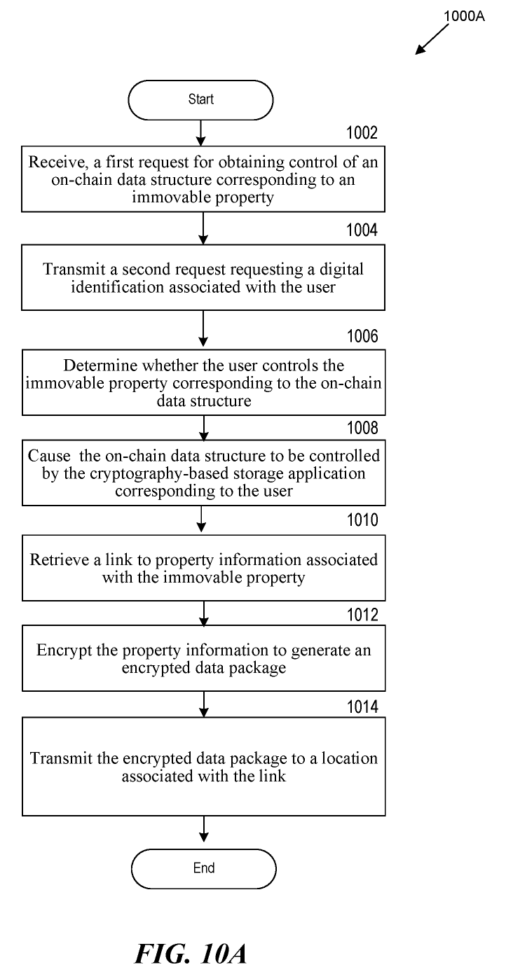

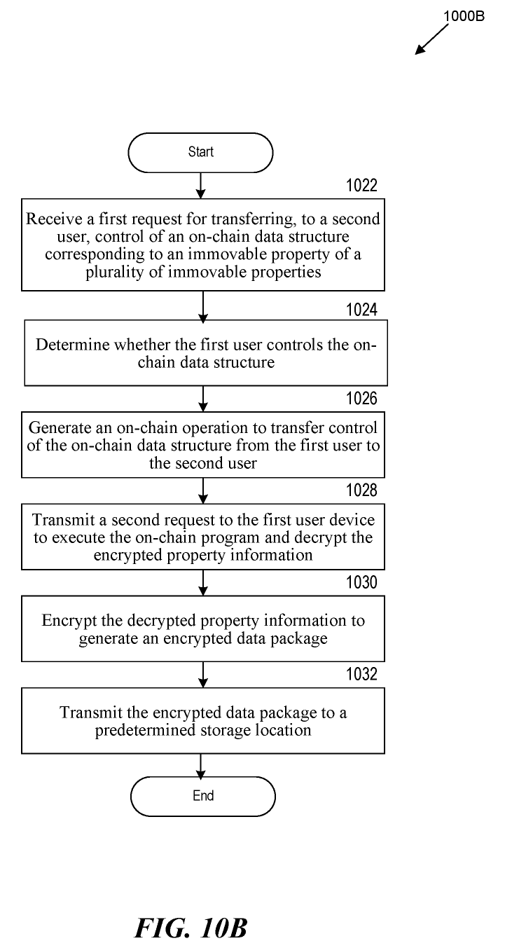

FIG. 10A is a flowchart 1000A of operations for linking on-chain data structures with immovable properties. The operations of FIG. 10A may use components described in relation to FIG. 9. In some embodiments, on-chain processing system 160 may include one or more components of computer system 900. At 1002, on-chain processing system 160 via one or more of processors 910a-910n receives a first request for obtaining control of an on-chain data structure corresponding to an immovable property. The on-chain processing system may receive the first request via network interface 940 and may store the first request in system memory 920.

At 1004, on-chain processing system 160 via one or more of processors 910a-910n transmits a second request requesting a digital identification associated with the user. For example, on-chain processing system 160 may use network interface 940 to transmit the second request. At 1006, on-chain processing system 160 via one or more of processors 910a-910n determines whether the user controls the immovable property corresponding to the on-chain data structure. At 1008, on-chain processing system 160 via one or more of processors 910a-910n causes the on-chain data structure to be controlled by the cryptography-based storage application corresponding to the user.

At 1010, on-chain processing system 160 via one or more of processors 910a-910n retrieves a link to property information associated with the immovable property. At 1012, on-chain processing system 160 via one or more of processors 910a-910n encrypts the property information to generate an encrypted data package. For example, communication subsystem 162 may be used to obtain the results, such as from a data node. At 1014, on-chain processing system 160 via one or more of processors 910a-910n transmits the encrypted data package to a location associated with the link.

FIG. 10B is a flowchart 1000B of operations for modifying on-chain data structures. The operations of FIG. 10B may use components described in relation to FIG. 9. In some embodiments, on-chain processing system 160 may include one or more components of computer system 900.

At 1022, on-chain processing system 160 via one or more of processors 910a-910n receives a first request for transferring, to a second user, control of an on-chain data structure corresponding to an immovable property of a plurality of immovable properties. One or more of processors 910a-910n may receive the first request over communication network 140 using network interface 940.

At 1024, on-chain processing system 160 via one or more of processors 910a-910n determines whether the first user controls the on-chain data structure. At 1026, on-chain processing system 160 via one or more of processors 910a-910n generates an on-chain operation to transfer control of the on-chain data structure from the first user to the second user. At 1028, on-chain processing system 160 via or more of processors 910a-910n transmits a second request to the first user device to execute the on-chain program and decrypt the encrypted property information.

At 1030, on-chain processing system 160 via one or more of processors 910a-910n encrypts the decrypted property information to generate an encrypted data package. At 1032, on-chain processing system 160 via one or more of processors 910a-910n transmits the encrypted data package to a predetermined storage location.

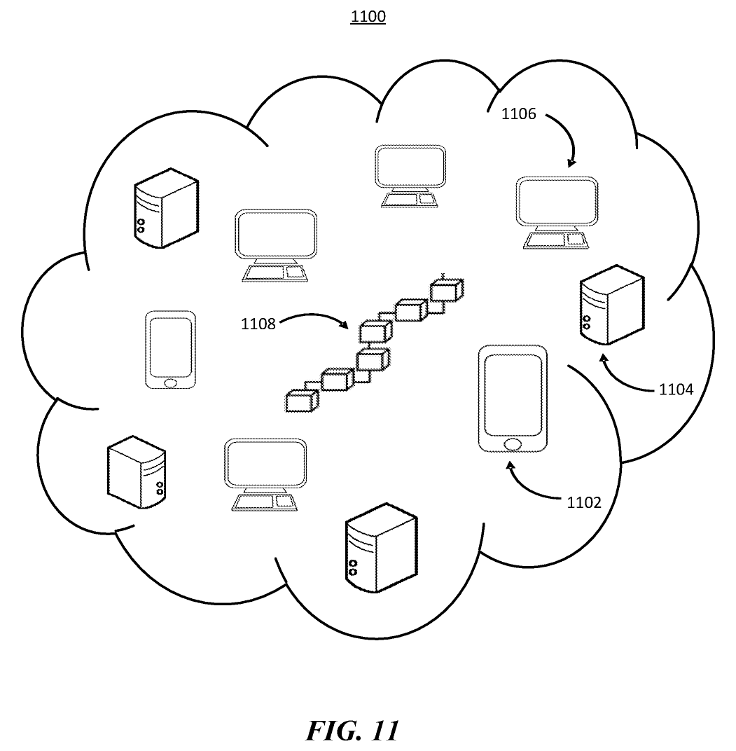

FIG. 11 shows an illustrative diagram for a decentralized environment for performing blockchain functions (sometimes referred to as blockchain operations), in accordance with one or more embodiments. For example, the diagram presents various components that may be used for transferring control of vehicle information to other users using NFTs in some embodiments.

As shown in FIG. 11, system 1100 may include multiple user devices (e.g., user device 1102, user device 1104, and/or user device 1106). For example, system 1100 may comprise a distributed state machine in which each of the components in FIG. 11 acts as a client of system 1100. For example, system 1100 (as well as other systems described herein) may comprise a large data structure that holds not only all accounts and balances but also a state machine, which can change from block to block according to a predefined set of rules and which can execute arbitrary machine code. The specific rules of changing state from block to block may be maintained by a virtual machine (e.g., a computer file implemented on and/or accessible by a user device, which behaves like an actual computer) for the system. For example, system 1100 may interact with, and facilitate the function of, blockchain 1108.

It should be noted that while shown as a smartphone, a personal computer, and a server in FIG. 11, the user devices may be any type of computing device, including, but not limited to, a laptop computer, a tablet computer, a handheld computer, and/or other computing equipment (e.g., a server), including “smart,” wireless, wearable, and/or mobile devices. It should be noted that embodiments describing the system 1100 performing a blockchain function may equally be applied to, and correspond to, an individual user device (e.g., user device 1102, user device 1104, and/or user device 1106) performing the blockchain function. That is, system 1100 may correspond to the user devices (e.g., user device 1102, user device 1104, and/or user device 1106) collectively or individually.

Each of the user devices may be used by the system to conduct blockchain functions. As referred to herein, “blockchain functions” may comprise any operations including and/or related to blockchains and blockchain technology. For example, blockchain functions may include conducting transactions, querying a distributed ledger, generating additional blocks for a blockchain, transmitting communications-related NFTs, performing encryption/decryption, exchanging public/private keys, and/or other operations related to blockchains and blockchain technology. In some embodiments, a blockchain function may comprise the creation, modification, detection, and/or execution of a smart contract or program stored on a blockchain. For example, a smart contract may comprise a program stored on a blockchain that is executed (e.g., automatically, without any intermediary’s involvement or time loss) when one or more predetermined conditions are met. In some embodiments, a blockchain function may comprise the creation, modification, exchange, and/or review of a token (e.g., a digital blockchain-specific asset), including an NFT. An NFT may comprise a token that is associated with a good, a service, a smart contract, and/or other content that may be verified by, and stored using, blockchain technology.

In some embodiments, blockchain functions may also comprise actions related to mechanisms that facilitate other blockchain functions (e.g., actions related to metering activities for blockchain functions on a given blockchain network). For example, Ethereum, which is an open-source, globally decentralized computing infrastructure that executes smart contracts, uses a blockchain to synchronize and store the system’s state changes. Ethereum uses a network-specific cryptocurrency called ether to meter and constrain execution resource costs. The metering mechanism is referred to as “gas.” As the system executes a smart contract, the system accounts for every blockchain function (e.g., computation, data access, transaction, etc.). Each blockchain function has a predetermined cost in units of gas (e.g., as determined based on a predefined set of rules for the system). When a blockchain function triggers the execution of a smart contract, the blockchain function may include an amount of gas that sets the upper limit of what can be consumed in running the smart contract. The system may terminate execution of the smart contract if the amount of gas consumed by computation exceeds the gas available in the blockchain function. For example, in Ethereum, gas comprises a mechanism for allowing Turing-complete computation while limiting the resources that any smart contract and/or blockchain function may consume.

In some embodiments, gas may be obtained as part of a blockchain function (e.g., a purchase) using a network-specific cryptocurrency (e.g., ether in the case of Ethereum). The system may require gas (or the amount of the network-specific cryptocurrency corresponding to the required amount of gas) to be transmitted with the blockchain function as an earmark to the blockchain function. In some embodiments, gas that is earmarked for a blockchain function may be refunded back to the originator of the blockchain function if, after the computation is executed, an amount remains unused.

As shown in FIG. 11, one or more user devices may include a digital wallet (e.g., digital wallet associated with user device 1104) used to perform blockchain functions. A digital wallet may be referred to as a cryptography-based storage application. For example, the digital wallet may comprise a repository that allows users to store, manage, and trade their cryptocurrencies and assets, interact with blockchains, and/or conduct blockchain functions using one or more applications. The digital wallet may be specific to a given blockchain protocol or may provide access to multiple blockchain protocols. In some embodiments, the system may use various types of wallets, such as hot wallets and cold wallets. Hot wallets are connected to the Internet, while cold wallets are not. Most digital wallet holders hold both a hot wallet and a cold wallet. Hot wallets are most often used to perform blockchain functions, while a cold wallet is generally used for managing a user account and may have no connection to the Internet.

As shown in FIG. 11, one or more user devices may include a private key and/or digital signature. Digital signature may sometimes be referred to as cryptographic signature. For example, system 1100 may use cryptographic systems for conducting blockchain functions, such as for transferring control of vehicle information to other users using NFTs. For example, system 1100 may use public key cryptography, which features a pair of digital keys (e.g., which may comprise strings of data). In such cases, each pair comprises a public key (e.g., which may be public) and a private key (e.g., which may be kept private). System 1100 may generate the key pairs using cryptographic algorithms (e.g., featuring one-way functions). System 1100 may then encrypt a message (or other blockchain function) using an intended receiver’s public key such that the encrypted message may be decrypted only with the receiver’s corresponding private key. In some embodiments, system 1100 may combine a message with a private key to create a digital signature on the message. For example, the digital signature may be used to verify the authenticity of blockchain functions. As an illustration, when conducting blockchain functions, system 1100 may use the digital signature to prove to every node in the system that it is authorized to conduct the blockchain functions.

For example, system 1100 may comprise a plurality of nodes for the blockchain network. Each node may correspond to a user device (e.g., user device 1102). A node for a blockchain network may comprise an application or other software that records and/or monitors peer connections to other nodes and/or miners for the blockchain network. For example, a miner comprises a node in a blockchain network that facilitates blockchain functions by verifying blockchain functions on the blockchain, adding new blocks to the existing chain, and/or ensuring that these additions are accurate. The nodes may continually record the state of the blockchain and respond to remote procedure requests for information about the blockchain.

For example, user device 1102 may request a blockchain function (e.g., conduct a transaction). The blockchain function may be authenticated by user device 1104 and/or another node (e.g., a user device in the community network of system 1100). For example, using cryptographic keys, system 1100 may identify users and give access to their respective user accounts (e.g., corresponding digital wallets) within system 1100. Using private keys (e.g., known only to the respective users) and public keys (e.g., known to the community network), system 1100 may create digital signatures to authenticate the users.

Following an authentication of the blockchain function, the blockchain function may be authorized. For example, after the blockchain function is authenticated between the users, system 1100 may authorize the blockchain function prior to adding it to the blockchain. System 1100 may add the blockchain function to blockchain 1108. System 1100 may perform this based on a consensus of the user devices within system 1100. For example, system 1100 may rely on a majority (or other metric) of the nodes in the community network (e.g., user device 1102, user device 1104, and/or user device 1106) to determine that the blockchain function is valid. In response to validation of the block, a node user device (e.g., user device 1102, user device 1104, and/or user device 1106) in the community network (e.g., a miner) may receive a reward (e.g., in a given cryptocurrency) as an incentive for validating the block.

To validate the blockchain function, system 1100 may use one or more validation protocols and/or validation (or consensus) mechanisms. For example, system 1100 may use a Proof of Work (“POW”) mechanism in which a user device must provide evidence that it performed computational work to validate a blockchain function, and thus, this mechanism provides a manner for achieving consensus in a decentralized manner, as well as preventing fraudulent validations. For example, the POW may involve iterations of a hashing algorithm. The user device that is successful aggregates and records blockchain functions from a mempool (e.g., a collection of all valid blockchain functions waiting to be confirmed by the blockchain network) into the next block. Alternatively, or additionally, system 1100 may use a Proof of Stake (“POS”) mechanism in which a user account (e.g., corresponding to a node on the blockchain network) is required to have, or “stake,” a predetermined amount of tokens in order for system 1100 to recognize it as a validator in the blockchain network.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

A1. A method comprising: receiving, from a user device corresponding to a user, a first request for obtaining control of an on-chain data structure corresponding to an immovable property of a plurality of immovable properties, wherein the first request comprises a first identifier associated with a cryptography-based storage application corresponding to the user and a second identifier corresponding to the immovable property of the plurality of immovable properties; in response to the first request, transmitting, to the user, a second request requesting a digital identification associated with the user, wherein the second request comprises a listing of permitted identity types; determining, based on the digital identification, whether the user controls the immovable property corresponding to the on-chain data structure; based on determining that the user controls the immovable property, causing an on-chain operation to be executed to assign control of the on-chain data structure to be controlled by the cryptography-based storage application corresponding to the user; retrieving, from the on-chain data structure, a link to property information associated with the immovable property, wherein the property information is stored off-chain; encrypting the property information using a public key associated with the cryptography-based storage application to generate an encrypted data package; and transmitting the encrypted data package to a location associated with the link.

A2. The method of any of the preceding embodiments, wherein the user device is hosting the cryptography-based storage application that stores a private key that is used to sign on-chain operations.

A3. The method of any of the preceding embodiments, further comprising retrieving, from one or more databases, a plurality of property identifiers corresponding to the plurality of immovable properties; generating, using an on-chain program, a plurality of on-chain data structures representing the plurality of immovable properties; retrieving a plurality of immovable property information sets for the plurality of immovable properties; and linking each on-chain data structure of the plurality of on-chain data structures with a corresponding immovable property information set of the plurality of immovable property information sets.

A4. The method of any of the preceding embodiments, wherein linking each on-chain data structure of the plurality of on-chain data structures with the corresponding immovable property information set of the plurality of immovable property information sets further comprises: selecting a first on-chain data structure of the plurality of on-chain data structures; determining a first property identifier associated with the first on-chain data structure of the plurality of on-chain data structures; generating, based on the first property identifier, the link to the corresponding immovable property information set; and storing the first property identifier within the on-chain data structure.

A5. The method of any of the preceding embodiments, wherein causing the on-chain operation to be executed to assign control of the on-chain data structure to be controlled by the cryptography-based storage application corresponding to the user further comprises: retrieving an identifier associated with the on-chain data structure; generating the on-chain operation that uses the identifier to assign the on-chain data structure to be controlled by the cryptography-based storage application; and transmitting a command to a blockchain node to execute the on-chain operation using the cryptography-based storage application on the user device, wherein the command comprises a cryptographic signature generated using a private key associated with a server.

A6. The method of any of the preceding embodiments, wherein retrieving the link to the property information associated with the immovable property further comprises: retrieving an identifier associated with the on-chain data structure; querying a node using the identifier for a corresponding on-chain data structure; and retrieving, from the on-chain data structure, the link to the property information.

A7. The method of any of the preceding embodiments, wherein encrypting the property information using the public key associated with the cryptography-based storage application to generate the encrypted data package further comprises: transmitting, to a node, a query for the on-chain data structure, wherein the query comprises an identifier of the on-chain data structure; receiving, from the node, the on-chain data structure; and extracting from the on-chain data structure an indicator of a controlling cryptography-based storage application to be used as the public key.

A8. One or more tangible, non-transitory, computer-readable media storing instructions that, when executed by a data processing apparatus, cause the data processing apparatus to perform operations comprising those of any of embodiments A1-A7.

A9. A system comprising: one or more processors; and memory storing instructions that, when executed by the one or more processors, cause the processors to effectuate operations comprising those of any of embodiments A1-A7.

A10. A system comprising means for performing any of embodiments A1-A7.

A11. A system comprising cloud-based circuitry for performing any of embodiments A1-A7.

B1. A method comprising: receiving, from a first user device corresponding to a first user, a first request for transferring, to a second user, control of an on-chain data structure corresponding to an immovable property of a plurality of immovable properties; determining whether the first user controls the on-chain data structure; based on determining that the first user controls the on-chain data structure, generating an on-chain operation to transfer control of the on-chain data structure from a first cryptography-based storage application corresponding to the first user to a second cryptography-based storage application corresponding to the second user; transmitting a second request to the first user device, wherein the first user device executes the on-chain operation and decrypts encrypted property information corresponding to the immovable property to generate decrypted property information, and wherein the encrypted property information is stored off-chain; based on the on-chain operation being completed and the encrypted property information being decrypted, receiving the decrypted property information; encrypting the decrypted property information using a public key associated with the second cryptography-based storage application to generate an encrypted data package; and transmitting the encrypted data package to a predetermined storage location.

B2. The method of any of the preceding embodiments, wherein the first request comprises a first identifier associated with the first cryptography-based storage application associated with the first user, a second identifier corresponding to the on-chain data structure, and a third identifier corresponding to the second user.

B3. The method of any of the preceding embodiments, wherein the second request comprises the on-chain operation, a link to the encrypted property information associated with the immovable property, and one or more instructions to execute the on-chain operation and decrypt the encrypted property information associated with the immovable property.

B4. The method of any of the preceding embodiments, further comprising: receiving, from an operator device, a data request for a subset of the encrypted property information, wherein the subset of the encrypted property information comprises a plurality of fields; determining that the plurality of fields comprising the subset of the encrypted property information comprises fields that are not private; and transmitting, to a second user device associated with the second cryptography-based storage application, a command for generating a single-user temporary token, wherein the single-user temporary token enables the operator device to access the plurality of fields, and wherein the command comprises a link to the encrypted property information and one or more identifiers corresponding to the plurality of fields, wherein the second user device uses the second cryptography-based storage application to decrypt the plurality of fields.

B5. The method of any of the preceding embodiments, further comprising: receiving, a plurality of data values for the plurality of fields from the second user device; retrieving an operator public key associated with an operator cryptography-based storage application, wherein the operator cryptography-based storage application corresponds to the operator device; encrypting the plurality of data values using the operator public key into encrypted values; and generating a temporary access on-chain data structure for accessing the plurality of data values.

B6. The method of any of the preceding embodiments, wherein generating the temporary access on-chain data structure for accessing the plurality of data values further comprises: generating a temporary link for storing the encrypted values; generating an on-chain command that uses an on-chain program to generate a new on-chain data structure, wherein the on-chain command comprises the temporary link and an identifier corresponding to the operator cryptography-based storage application; and transmitting the on-chain command to a blockchain node of a blockchain to commit the temporary access on-chain data structure to the blockchain.

B7. The method of any of the preceding embodiments, further comprising: determining that the temporary access on-chain data structure has expired, wherein the temporary access on-chain data structure stores one or more expiration criteria on a blockchain; based on determining that the temporary access on-chain data structure has expired, retrieving a corresponding link from the temporary access on-chain data structure; and deleting the encrypted data package from a network location associated with a link to the encrypted property information.

B8. The method of any of the preceding embodiments, further comprising receiving the decrypted property information from the first user device.

B9. One or more tangible, non-transitory, computer-readable media storing instructions that, when executed by a data processing apparatus, cause the data processing apparatus to perform operations comprising those of any of embodiments B1-B8.

B10. A system comprising: one or more processors; and memory storing instructions that, when executed by the one or more processors, cause the processors to effectuate operations comprising those of any of embodiments B1-B8.

B11. A system comprising means for performing any of embodiments B1-B8.

B12. A system comprising cloud-based circuitry for performing any of embodiments B1-B8.

What is claimed is:

1. A system linking properties with on-chain data structures, the system comprising:
one or more processors; and
one or more non-transitory, computer-readable storage media storing instructions, which, when executed by the one or more processors, cause the one or more processors to perform operations comprising:
receiving, from a user device corresponding to a user, a first request for obtaining control of an on-chain data structure corresponding to an immovable property of a plurality of immovable properties, wherein the first request comprises a first identifier associated with a cryptography-based storage application corresponding to the user and a second identifier corresponding to the immovable property of the plurality of immovable properties;
in response to the first request, transmitting, to the user, a second request requesting a digital identification associated with the user, wherein the second request comprises a listing of permitted identity types;
determining, based on the digital identification, whether the user controls the immovable property corresponding to the on-chain data structure;
based on determining that the user controls the immovable property, causing an on-chain operation to be executed to assign control of the on-chain data structure to be controlled by the cryptography-based storage application corresponding to the user;
retrieving, from the on-chain data structure, a link to property information associated with the immovable property, wherein the property information is stored off-chain;
encrypting the property information using a public key associated with the cryptography-based storage application to generate an encrypted data package; and
transmitting the encrypted data package to a location associated with the link.

2. The system of claim 1, wherein the instructions further cause the one or more processors to perform operations comprising:
retrieving, from one or more databases, a plurality of property identifiers corresponding to the plurality of immovable properties;
generating, using an on-chain program, a plurality of on-chain data structures representing the plurality of immovable properties;
retrieving a plurality of immovable property information sets for the plurality of immovable properties; and
linking each on-chain data structure of the plurality of on-chain data structures with a corresponding immovable property information set of the plurality of immovable property information sets.

3. The system of claim 2, wherein the instructions for linking each on-chain data structure of the plurality of on-chain data structures with the corresponding immovable property information set of the plurality of immovable property information sets further cause the one or more processors to perform operations comprising:
selecting a first on-chain data structure of the plurality of on-chain data structures;
determining a first property identifier associated with the first on-chain data structure of the plurality of on-chain data structures;
generating, based on the first property identifier, the link to the corresponding immovable property information set; and
storing the first property identifier within the on-chain data structure.

4. The system of claim 1, wherein the instructions for causing the on-chain operation to be executed to assign control of the on-chain data structure to be controlled by the cryptography-based storage application corresponding to the user further cause the one or more processors to perform operations comprising:
retrieving an identifier associated with the on-chain data structure;
generating the on-chain operation that uses the identifier to assign the on-chain data structure to be controlled by the cryptography-based storage application; and
transmitting a command to a blockchain node to execute the on-chain operation using the cryptography-based storage application on the user device, wherein the command comprises a cryptographic signature generated using a private key associated with a server.

5. The system of claim 1, wherein the instructions for retrieving the link to the property information associated with the immovable property further cause the one or more processors to perform operations comprising:
retrieving an identifier associated with the on-chain data structure;
querying a node using the identifier for a corresponding on-chain data structure; and
retrieving, from the on-chain data structure, the link to the property information.

6. The system of claim 1, wherein the instructions for encrypting the property information using the public key associated with the cryptography-based storage application to generate the encrypted data package further cause the one or more processors to perform operations comprising:
transmitting, to a node, a query for the on-chain data structure, wherein the query comprises an identifier of the on-chain data structure;
receiving, from the node, the on-chain data structure; and
extracting from the on-chain data structure an indicator of a controlling cryptography-based storage application to be used as the public key.

7. A method for linking properties with on-chain data structures, the method comprising:
receiving, from a user device corresponding to a user, a first request for obtaining control of an on-chain data structure corresponding to an immovable property of a plurality of immovable properties, wherein the first request comprises a first identifier associated with a cryptography-based storage application corresponding to the user and a second identifier corresponding to the immovable property of the plurality of immovable properties;
in response to the first request, transmitting, to the user, a second request requesting a digital identification associated with the user, wherein the second request comprises a listing of permitted identity types;
determining, based on the digital identification, whether the user controls the immovable property corresponding to the on-chain data structure;
based on determining that the user controls the immovable property, causing an on-chain operation to be executed to assign control of the on-chain data structure to be controlled by the cryptography-based storage application corresponding to the user;
retrieving, from the on-chain data structure, a link to property information associated with the immovable property, wherein the property information is stored off-chain;
encrypting the property information using a public key associated with the cryptography-based storage application to generate an encrypted data package; and
transmitting the encrypted data package to a location associated with the link.

8. The method of claim 7, wherein the user device is hosting the cryptography-based storage application that stores a private key that is used to sign on-chain operations.

9. The method of claim 7, further comprising:
retrieving, from one or more databases, a plurality of property identifiers corresponding to the plurality of immovable properties;
generating, using an on-chain program, a plurality of on-chain data structures representing the plurality of immovable properties;
retrieving a plurality of immovable property information sets for the plurality of immovable properties; and
linking each on-chain data structure of the plurality of on-chain data structures with a corresponding immovable property information set of the plurality of immovable property information sets.

10. The method of claim 9, wherein linking each on-chain data structure of the plurality of on-chain data structures with the corresponding immovable property information set of the plurality of immovable property information sets further comprises:
selecting a first on-chain data structure of the plurality of on-chain data structures;
determining a first property identifier associated with the first on-chain data structure of the plurality of on-chain data structures;
generating, based on the first property identifier, the link to the corresponding immovable property information set; and
storing the first property identifier within the on-chain data structure.

11. The method of claim 7, wherein causing the on-chain operation to be executed to assign control of the on-chain data structure to be controlled by the cryptography-based storage application corresponding to the user further comprises:
retrieving an identifier associated with the on-chain data structure;
generating the on-chain operation that uses the identifier to assign the on-chain data structure to be controlled by the cryptography-based storage application; and
transmitting a command to a blockchain node to execute the on-chain operation using the cryptography-based storage application on the user device, wherein the command comprises a cryptographic signature generated using a private key associated with a server.

12. The method of claim 7, wherein retrieving the link to the property information associated with the immovable property further comprises:
retrieving an identifier associated with the on-chain data structure;
querying a node using the identifier for a corresponding on-chain data structure; and
retrieving, from the on-chain data structure, the link to the property information.

13. The method of claim 7, wherein encrypting the property information using the public key associated with the cryptography-based storage application to generate the encrypted data package further comprises:
transmitting, to a node, a query for the on-chain data structure, wherein the query comprises an identifier of the on-chain data structure;
receiving, from the node, the on-chain data structure; and
extracting from the on-chain data structure an indicator of a controlling cryptography-based storage application to be used as the public key.

14. One or more non-transitory, computer-readable storage media storing instructions that when executed by one or more processors cause the one or more processors to perform operations comprising:
receiving, from a user device corresponding to a user, a first request for obtaining control of an on-chain data structure corresponding to an immovable property of a plurality of immovable properties, wherein the first request comprises a first identifier associated with a cryptography-based storage application corresponding to the user and a second identifier corresponding to the immovable property of the plurality of immovable properties;
in response to the first request, transmitting, to the user, a second request requesting a digital identification associated with the user, wherein the second request comprises a listing of permitted identity types;
determining, based on the digital identification, whether the user controls the immovable property corresponding to the on-chain data structure;
based on determining that the user controls the immovable property, causing an on-chain operation to be executed to assign control of the on-chain data structure to be controlled by the cryptography-based storage application corresponding to the user;
retrieving, from the on-chain data structure, a link to property information associated with the immovable property, wherein the property information is stored off-chain;
encrypting the property information using a public key associated with the cryptography-based storage application to generate an encrypted data package; and
transmitting the encrypted data package to a location associated with the link.

15. The one or more non-transitory, computer-readable storage media of claim 14, wherein the user device is hosting the cryptography-based storage application that stores a private key that is used to sign on-chain operations.

16. The one or more non-transitory, computer-readable storage media of claim 14, wherein the instructions further cause the one or more processors to perform operations comprising:
retrieving, from one or more databases, a plurality of property identifiers corresponding to the plurality of immovable properties;
generating, using an on-chain program, a plurality of on-chain data structures representing the plurality of immovable properties;
retrieving a plurality of immovable property information sets for the plurality of immovable properties; and
linking each on-chain data structure of the plurality of on-chain data structures with a corresponding immovable property information set of the plurality of immovable property information sets.

17. The one or more non-transitory, computer-readable storage media of claim 16, wherein the instructions for linking each on-chain data structure of the plurality of on-chain data structures with the corresponding immovable property information set of the plurality of immovable property information sets further cause the one or more processors to perform operations comprising:
selecting a first on-chain data structure of the plurality of on-chain data structures;
determining a first property identifier associated with the first on-chain data structure of the plurality of on-chain data structures;
generating, based on the first property identifier, the link to the corresponding immovable property information set; and
storing the first property identifier within the on-chain data structure.

18. The one or more non-transitory, computer-readable storage media of claim 14, wherein the instructions for causing the on-chain operation to be executed to assign control of the on-chain data structure to be controlled by the cryptography-based storage application corresponding to the user further cause the one or more processors to perform operations comprising:
retrieving an identifier associated with the on-chain data structure;
generating the on-chain operation that uses the identifier to assign the on-chain data structure to be controlled by the cryptography-based storage application; and
transmitting a command to a blockchain node to execute the on-chain operation using the cryptography-based storage application on the user device, wherein the command comprises a cryptographic signature generated using a private key associated with a server.

19. The one or more non-transitory, computer-readable storage media of claim 14, wherein the instructions for retrieving the link to the property information associated with the immovable property further cause the one or more processors to perform operations comprising:
retrieving an identifier associated with the on-chain data structure;
querying a node using the identifier for a corresponding on-chain data structure; and
retrieving, from the on-chain data structure, the link to the property information.

20. The one or more non-transitory, computer-readable storage media of claim 14, wherein the instructions for encrypting the property information using the public key associated with the cryptography-based storage application to generate the encrypted data package further cause the one or more processors to perform operations comprising:
transmitting, to a node, a query for the on-chain data structure, wherein the query comprises an identifier of the on-chain data structure;
receiving, from the node, the on-chain data structure; and
extracting from the on-chain data structure an indicator of a controlling cryptography-based storage application to be used as the public key.
